(19) United States
(12) Patent Application Publication
(10) Pub. No.: US 2014/0061451 A1
(43) Pub. Date: Mar. 6, 2014

(54) BIDIRECTIONAL OPTICAL MODULE

(71) Applicant: Electronics and Telecommunications Research Institute, (US)

(72) Inventors: Hyoung-Jun Park, Gwangju-si (KR); Young-Soon Heo, Gwangju-si (KR); Kwon-Seob Lim, Gwangju-si (KR); Hyun-Seo Kang, Gwangju-si (KR); Young-Sun Kim, Daejeon-si (KR)

(73) Assignee: Electronics and Telecommunications Research Institute, Daejeon-si (KR)

(21) Appl. No.: 13/844,977

(22) Filed: Mar. 17, 2013

(30) Foreign Application Priority Data
Aug. 30, 2012 (KR) 10-2012-0095789

(51) Int. Cl. G02B 6/42

(52) U.S. Cl. CPC G02B 6/4246
USPC 250/227.11

(57) ABSTRACT

A bidirectional optical module for communicating optical signals bidirectionally via a single optical fiber is provided. The bidirectional optical module includes an optical fiber, a stem having a cavity formed at one side thereof and first alignment marks formed near an entrance of the cavity, a light emitting device mounted on the cavity, a light receiving device mounted on the cavity and spaced apart from the light emitting device, a filter block part fixed near the entrance of the cavity and configured to deliver light output from the light emitting device to the optical fiber and deliver light input through the optical fiber to the light receiving device, and a cap configured to accommodate the light emitting device, light receiving device, and a filter block part between the cap and the stem.

### CROSS-REFERENCE TO RELATED APPLICATION

This application claims the benefit under 35 U.S.C. §119(a) of a Korean Patent Application No. 10-2012-0095789, filed on Aug. 30, 2012, the entire disclosure of which is incorporated herein by reference for all purposes.

### BACKGROUND

1. Field

The following description relates to a bidirectional optical module for communicating optical signals bidirectionally via a single optical fiber.

2. Description of the Related Art

In recent years, as home video game consoles and Blu-ray players that can support full high-definition (HD) 3D images are widely used and digital broadcasting is supported, displays is are increasingly large-scale, and also high-definition multimedia interface (HDMI) cables for transmission of large-scale high-quality audio/video (A/V) signals between multimedia devices and linkage of the devices have attracted attention.

Due to electromagnetic interference (EMI) and a limitation in transmission capacity that 5 Gbps signals cannot be transmitted farther than 5 meters, multimedia devices with conventional coaxial cables have some difficulties for remote image transmission, for example, in an electronic scoreboard at a stadium, a projector in a large concert hall, or a digital display in an exhibition center.

To overcome the problems in the conventional coaxial cables, demand for and interest in active optical cables (AOCs) have increased. Moreover, technologies for various types of bidirectional optical modules having light transmitting/receiving modules are being proposed.

In general, the bidirectional optical module transmits light output from a laser diode through an optical filter to optically couple the light to an optical fiber, and reflects light input through the optical fiber using the optical filter to optically couple the light to a photodiode. In manufacturing of the bidirectional optical module, the work of aligning the optical fiber, laser diode, photodiode, and optical filter is performed such that the bidirectional optical module may have the maximum optical coupling efficiency. Here, for mass production of bidirectional optical modules, the alignment work, especially for the optical filter, needs to be easily performed.

### SUMMARY

The following description relates to a bidirectional optical module for which productivity can be enhanced.

In one general aspect, the bidirectional optical module includes: an optical fiber; a stem having a cavity formed at one side thereof and first alignment marks formed near an entrance of the cavity; a light emitting device mounted on the cavity; a light receiving device mounted on the cavity to be spaced apart from the light emitting device; a filter block part fixed near the entrance of the cavity and configured to deliver light output from the light emitting device to the optical fiber and deliver light input through the optical fiber to the light receiving device, wherein the filter block part includes second alignment marks corresponding to the first alignment marks and thus is aligned near the entrance of the cavity; and a cap configured to accommodate the light emitting device, the light receiving device, and a filter block part between the cap and the stem.

Other features and aspects will be apparent from the following detailed description, the drawings, and the claims

### BRIEF DESCRIPTION OF THE DRAWINGS

FIG. 1 is a side sectional view of a bidirectional optical module according to an embodiment of the present invention.

FIG. 2 is an exploded perspective view of the bidirectional optical module in FIG. 1.

FIG. 3 is a perspective view of first and second support blocks in FIG. 2.

FIG. 4 is a perspective view illustrating a state in which a filter block part is aligned with a stem in FIG. 2.

FIG. 5 is a perspective view illustrating a state in which a cap is aligned with a stem in FIG. 2.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

Hereinafter, preferred embodiments of the present invention will be described below in more detail with reference to the accompanying drawings.

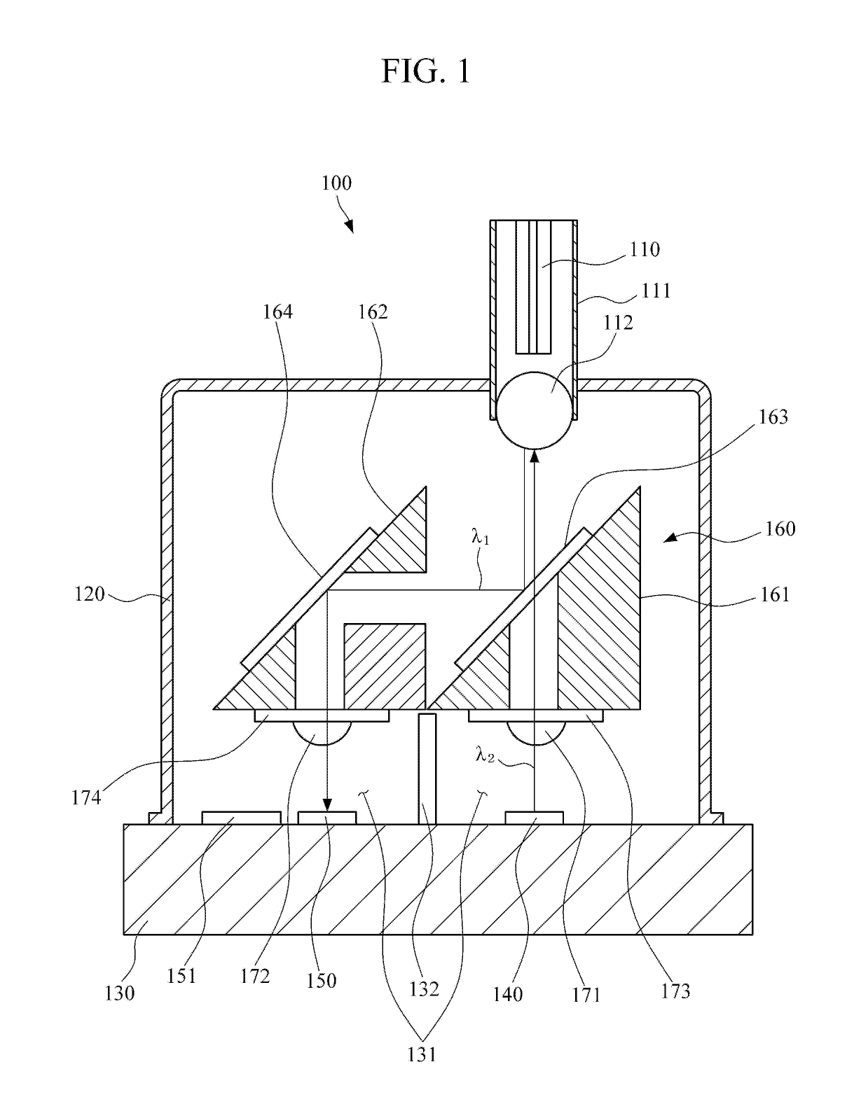

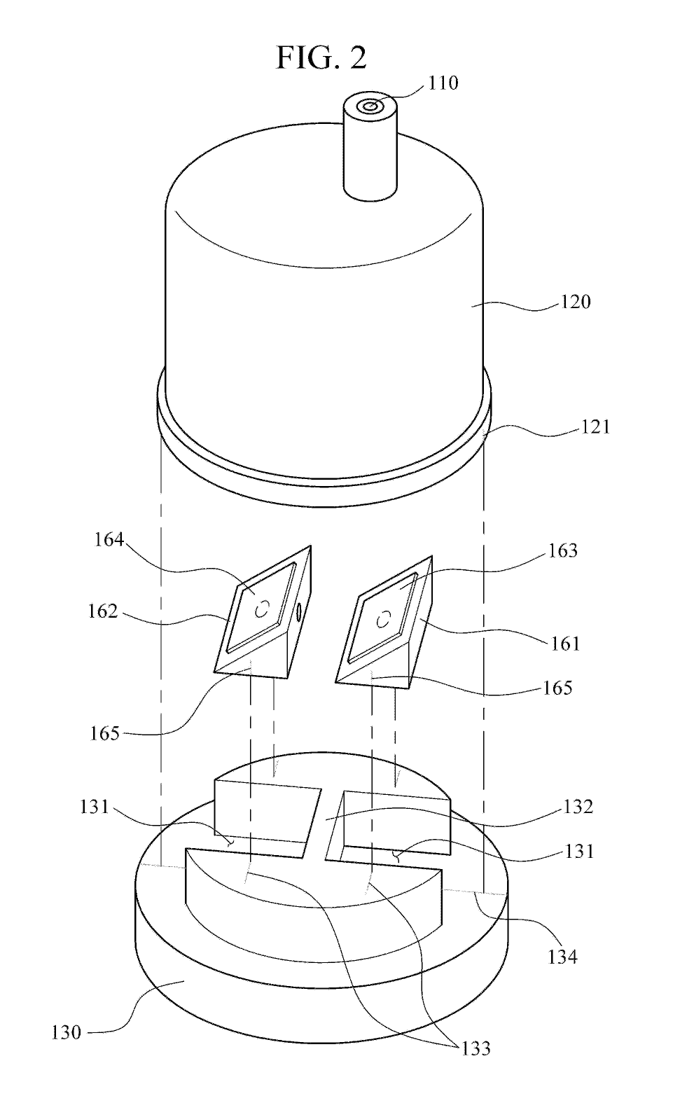

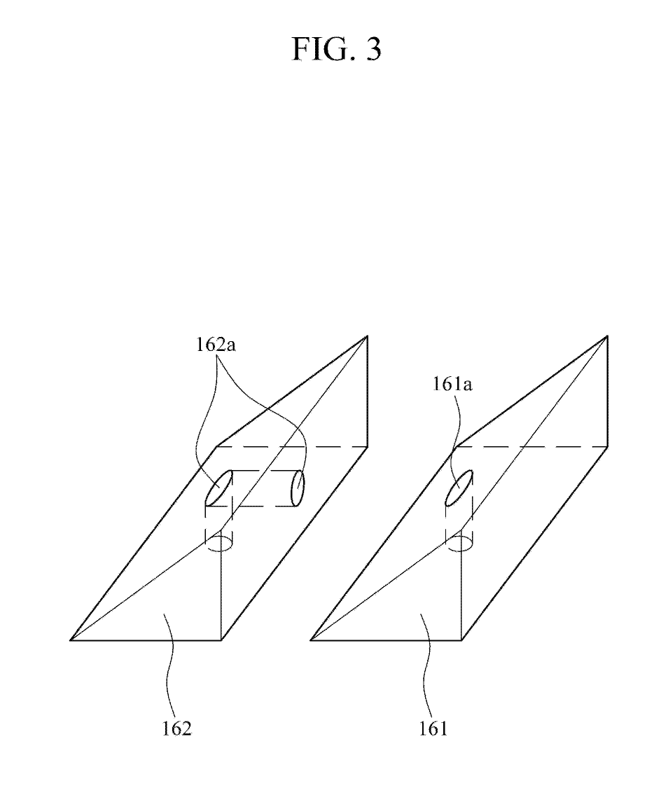

FIG. 1 is a side sectional view of a bidirectional optical module according to an embodiment of the present invention. FIG. 2 is an exploded perspective view of FIG. 1. FIG. 3 is a perspective view of first and second support blocks as shown in FIG. 2.

Referring to FIGS. 1 to 3, the bidirectional optical module 100 includes an optical fiber 110, a cap 120, a stem 130, a light emitting device 140, a light receiving device 150, and a filter block part 160.

The optical fiber 110 receives input light 2d from the outside and then transmits input light λ1 to the light receiving device 150, and receives output light λ2 from the light emitting device 140 and then transmits output light λ2 to the outside. The optical fiber 110 may be supported in a holder 111. The holder 111 may be inserted into and combined with a hole that is formed in the cap 120.

In the holder 111, a focusing lens 112 may be supported. The focusing lens 112 is positioned between the optical fiber 110 and the filter block part 160. The focusing lens 112 may focus light that is output from the light emitting device 140 and transmitted through the filter block part 160 to deliver the focused light to the optical fiber 110. The focusing lens 112 may be formed of a ball lens, etc.

The cap 120 has an inner space. The cap 120 may have a hole at its upper portion, where the holder 111 may be combined, and an opening structure at its lower portion. The opening structure at the lower portion of the cap 120 may be fixed along the top edge of the stem 130, thereby sealing the inner space of the cap 120. The sealed space of the cap 120 may accommodate and protect the light emitting device 140, the light receiving device 150, and the filter block part 160.

The stem 130 has a cavity 131 formed thereon. The light emitting device 140 and the light receiving device 150 are mounted on the cavity 131. As shown in FIG. 2, the cavity 131 may be formed to have a concave shape recessed at a certain depth from the top of the stem 130. Moreover, the top edge of the stem 130 may be recessed to the depth of the cavity 131. The opening at the lower portion of the cap 120 may be fixed at the recessed top edge of the stem 130.

The cavity 131 may have a partition wall 132 formed to separate the light emitting device 140 and the light receiving device 150. The partition wall 132 may be formed to have a height corresponding to the depth of the cavity 131. The partition wall 132 can minimize interference between light λ2 emitted from the light emitting device 140 and light λ1 incident on the light receiving device 150. First alignment marks 133 are formed near the entrance of the cavity 131. The stem 130 may be a transistor outline stem (TO stem).

The light emitting device 140 is mounted on the cavity 131. The light emitting device 140 may be formed of a laser diode, etc. The light receiving device 150 is also mounted on the cavity 131 separately from the light emitting device 140. The light receiving device 150 may be formed of a photo diode, etc. A trans-impedance amplifier 151 is an amplifier that converts a current signal, which is output from the light receiving device 150, to a voltage signal, and may be mounted at one side of the light receiving device 150.

The light emitting device 140 and the light receiving device 150 may be mounted on the cavity 131 and die-bonded or wire-bonded on the stem 130. At this point, the light emitting device 140 and the light receiving device 150 may be mounted using an alignment mark (not shown), thereby minimizing an alignment error.

The filter block part 160 is fixed near the entrance of the cavity 131. The filter block part 160 delivers output light λ2 output from the light emitting device 140 to the optical fiber 110 and delivers input light λ1 input through the optical fiber 110 to the light receiving device 150. That is, the filter block part 160 optically couples the light emitting device 140 and the optical fiber 110, and also optically couples the optical fiber 110 and light receiving device 150.

For example, the optical fiber 110 and the light emitting device 140 may be disposed to corresponding to each other. The filter block part 160 may allow output light λ2 from the light emitting device 140 to pass therethrough to the optical fiber 110 and reflect input light λ1 input through the optical fiber 110 to deliver the reflected light to the light receiving device 150.

To this end, the filter block part 160 may include a first support block 161, a second support block 162, a first optical filter 163, and a second optical filter 164. The first support block 161 and the second support block 162 may each have a right triangular prism shape with a 45 degree inclined plane.

The first optical filter 163 is provided on the 45 degree inclined plane of the first support block 161. The first optical filter 163 passes only light λ2 in a wavelength band that is output from the light emitting device 140 therethrough and reflects light in other wavelength bands. The second optical filter 164 is provided on the 45 degree inclined plane of the second support block 162. The second optical filter 164 reflects light λ1 in other wavelength bands that is input through the optical fiber 110. The first and second optical filters 163 and 164 may each be formed of a wavelength-division multiplexing (WDM) thin film filter. Alternatively, the second optical filter 163 may be formed of a reflection mirror. The first and second optical filters 163 and 164 may be fixed to the first and second support blocks 161 and 162 using ultraviolet epoxy.

The first and second support blocks 161 and 162 may be fixed near the entrance of the cavity 131 in such a manner that the first optical filter 163 passes output light λ2 output from the light emitting device 140 therethrough to deliver the output light λ2 to the optical fiber 110 and the first optical filter 163 and then the second optical filter 164 sequentially reflect input light λ1 input through the optical fiber 110 to deliver the input light λ1 to the light receiving device 150.

That is, while the first support block 161 is disposed on the top of the light emitting device 140, the second support block 162 is disposed on the top of the light receiving device 150. In this case, the first optical filter 163 is disposed to reflect input light λ1 input from the optical fiber 110 at 45 degrees to deliver the reflected light to the second optical filter 164. Also, the second optical filter 164 is disposed to reflect input light λ1, which is reflected by the first optical filter 163, at 90 degrees to deliver the reflected light to the light receiving device 150.

The first support block 163 has a first through hole 161a formed on an area through which output light λ2 output from the light emitting device 140 passes. The first through hole 161a has a path corresponding to a path of output light λ2 being output from the light emitting device 140 and then straightly delivered to the optical fiber 110.

The second support block 162 has a second through hole 162a formed on an area through which input light λ1 input through the optical fiber 110 passes after passing through the first optical filter 163 and then the second optical filter 164. The second through hole 162a has a path corresponding to a path of input light λ1 being reflected by the first optical filter 163 at 45 degrees, delivered to the second optical filter 164, reflected by the second optical filter 164 at 90 degrees, and then input to the light receiving device 150. The first and second support blocks 161 and 162 may each be formed of a plastic injection molding product that is injected into a mold. Accordingly, the first and second support blocks 161 and 162 can be manufactured on a large scale at a low cost.

The first support block 161 may have an entrance of the first through hole 161a that is positioned on a bottom surface of the first support block 161 and provided with a first lens 171 at the entrance of the first through hole 161a. The first lens 171 is intended to reduce a radiation angle of output light λ2 output from the light emitting device 140. The first lens 171 is formed of a hemispherical lens, a convex part of which may be disposed toward the light emitting device 140.

The second support block 162 may have an exit of the second through hole 162a that is positioned on a bottom surface of the second support block 162 and provided with a second lens 172 at the entrance of the second through hole 162a. The second lens 172 is intended to focus input light λ1 reflected by the second optical filter 164. The second lens 172 is formed of a hemispherical lens, a convex part of which may be disposed toward the light receiving device 150. A first wavelength blocking filter 173 may be inserted between the entrance of the first through hole 161a and the first lens 171. A second wavelength blocking filter 174 may be inserted between the exit of the second through hole 162a and the second lens 172. The first and second wavelength blocking filters 173 and 174 each block a specific wavelength band, thereby reducing optical crosstalk. The first and second wavelength blocking filters 173 and 174 may be fixed in the first and second support blocks 161 and 162 using ultraviolet epoxy. Furthermore, the first and second lenses 171 and 172 may be fixed in the first and second wavelength blocking filters 173 and 174 using ultraviolet epoxy.

The invention should not be construed as being limited to the examples illustrated herein. The optical fiber 110 and the light receiving device 150 may be disposed to correspond to each other, and the filter block part 160 may allow light λ1 input through the optical fiber 110 to pass therethrough to the light receiving device 150 and reflect light λ2 output from the light emitting device 140 to deliver the reflected light to the optical fiber 110.

The filter block part 160 has second alignment marks 165. When the filter block part 160 includes the first and second support blocks 161 and 162, the first and second support blocks 161 and 162 each have the second alignment marks 165. The second alignment marks 165 correspond to the first alignment marks 133 such that the first and second support blocks 161 and 163 may be aligned near the entrance of the cavity 131.

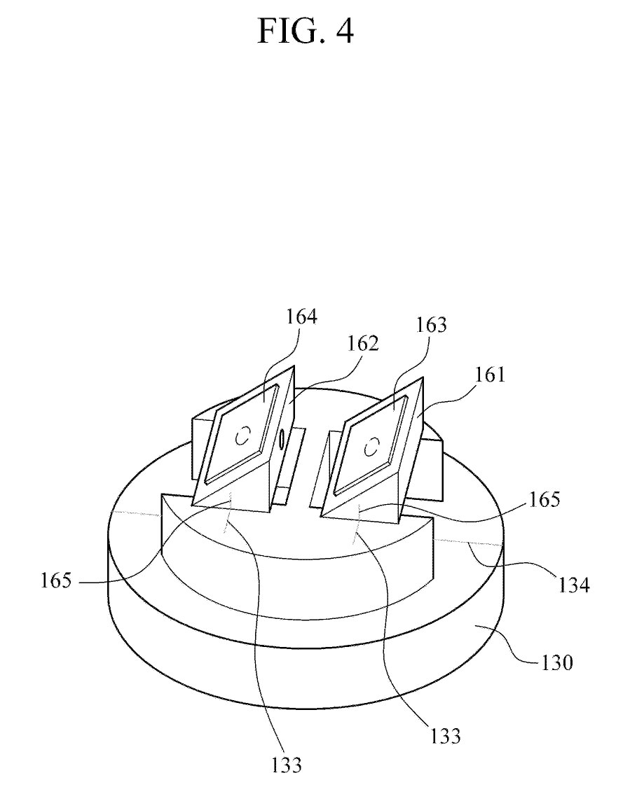

Accordingly, as shown in FIG. 4, the second alignment marks 165 correspond to the first alignment marks 133 such that the first and second support blocks 161 and 162 may be passively aligned near the entrance of the cavity 131. In this case, an alignment jig may be used to align the first and second support blocks 161 and 162 near the entrance of the cavity 131. After the first and second support blocks 161 and 162 are aligned near the entrance of the cavity 131, the first and second support blocks 161 and 162 may be fixed near the entrance of the cavity 131 using ultraviolet epoxy. In this way, the first and second support blocks 161 and 162 may be passively aligned with the stem 130, thereby enhancing the productivity of the bidirectional optical module 100.

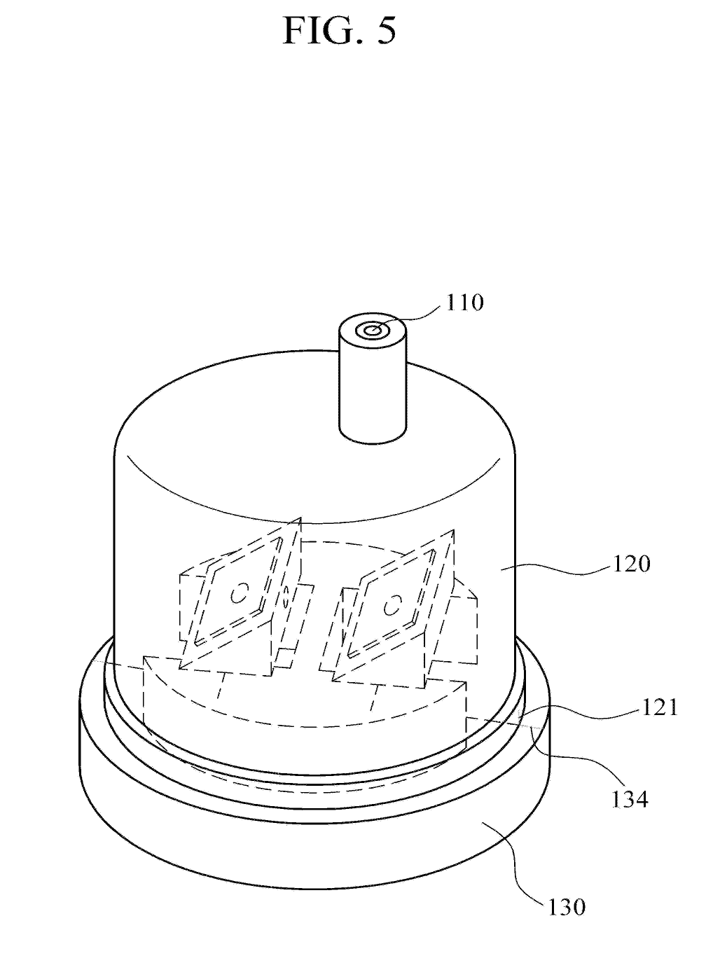

The stem 130 may have third alignment marks 134 formed on the top edge of the stem 130. The cap 120 may have fourth alignment marks 121 corresponding to the third alignment marks 134, thereby being aligned with the stem 130. Accordingly, as shown in FIG. 5, as the fourth alignment marks 121 are aligned with the third alignment marks 134, the cap 120 may be passively aligned with the stem 130. Before the cap 120 is aligned with the stem 130, a sealing process for sealing with the cap 120 may be performed on the stem 130 Furthermore, after the cap 120 is aligned with the stem 130 using the third alignment marks 134 and the fourth alignment marks 121, the cap 120 may be fixed by laser welding. As another example, the cap 120 and the stem 130 can be actively aligned using a method of measuring an output of light output from the optical fiber 110.

According to the present invention, the filter block part can be passively aligned with the stem having the light emitting device and the light receiving device mounted side by side, thereby enhancing the productivity of the bidirectional optical module.

According to the present invention, the filter block part has a structure in which the first and second support blocks formed of an injection molding product of a right triangular prism shape are each provided with a thin film filter. Thus, the filter block part can be manufactured on a large scale at a low cost.

Accordingly, the present invention can be effectively and easily applied to the manufacturing of a low-price bidirectional optical module, using a large diameter optical fiber such as a multi-mode fiber and a plastic optical fiber (POF).

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A bidirectional optical module, comprising:
an optical fiber;
a stem having a cavity formed at one side thereof and first alignment marks formed near an entrance of the cavity;
a light emitting device mounted on the cavity;
a light receiving device mounted on the cavity and spaced apart from the light emitting device;
a filter block part fixed near the entrance of the cavity and configured to deliver light output from the light emitting device to the optical fiber and deliver light input through the optical fiber to the light receiving device, wherein the filter block part includes second alignment marks corresponding to the first alignment marks and thus is aligned near the entrance of the cavity; and
a cap configured to accommodate the light emitting device, light receiving device, and a filter block part between the cap and the stem.

2. The bidirectional optical module of claim 1, wherein the optical fiber and the light emitting device are disposed to correspond to each other, and
the filter block part allows light output from the light emitting device to pass therethrough to deliver the passing light to the optical fiber and reflects light input through the optical fiber to deliver the reflected light to the light receiving device.

3. The bidirectional optical module of claim 2, wherein the filter block part comprises a first support block having a right triangular prism shape with a 45 degree inclined plane, a second support block having a right triangular prism shape with a 45 degree inclined plane, a first optical filter provided on the 45 degree inclined plane of the first support block and configured to transmit only light in a wavelength band that is output from the light emitting device, and a second optical filter provided on the 45 degree inclined plane of the second support block and configured to reflect light in a wavelength band that is input through the optical fiber, and
the first and second support blocks are fixed near the entrance of the cavity and configured to transmit light output from the light emitting device through the first optical filter to deliver the transmitted light to the optical fiber and reflect light input through the optical fiber using the first optical filter and the second optical filter to deliver the reflected light to the light receiving device.

4. The bidirectional optical module of claim 3, wherein the first support block is formed of an injection molding product and has a first through hole formed on an area through which light output from the light emitting device passes, and
the second support block is formed of an injection molding product and has a second through hole formed on an area through which light input through the optical fiber passes after passing through the first optical filter and then the second optical filter.

5. The bidirectional optical module of claim 4, wherein the first through hole is provided at an entrance thereof with a first lens configured to reduce a radiation angle of the light output from the light emitting device, and
the second through hole is provided at an exit thereof with a second lens configured to focus the light reflected by the second optical filter.

6. The bidirectional optical module of claim 5, wherein a first wavelength blocking filter is inserted between the entrance of the first through hole and the first lens, and a second wavelength blocking filter is inserted between the exit of the second through hole and the second lens.

7. The bidirectional optical module of claim 3, wherein the first and second optical filters are each a wavelength-division multiplexing (WDM) thin film filter.

8. The bidirectional optical module of claim 1, wherein, a focusing lens is provided between the optical fiber and the filter block part to focus light output from the light emitting device and passing through the filter block part to deliver the focused light to the optical fiber.

9. The bidirectional optical module of claim 1, wherein a partition wall is formed in the cavity to separate the light emitting device and the light receiving device.

10. The bidirectional optical module of claim 1, wherein the stem has third alignment marks formed on the one side thereof, and the cap has fourth alignment marks corresponding to the third alignment marks for alignment with the stem.
